(19) United States
(12) Patent Application Publication
(10) Pub. No.: US 2023/0053695 A1
(43) Pub. Date: Feb. 23, 2023

(54) ARRAY OF ELECTRIFIED WICKS FOR PRODUCTION OF AQUEOUS DROPLETS

(71) Applicant: PALO ALTO RESEARCH CENTER INCORPORATED, Palo Alto, CA (US)

(72) Inventor: Kathryn F. Murphy, Redwood City, CA (US)

(21) Appl. No.: 17/404,216

(22) Filed: Aug. 17, 2021

(51) Int. Cl. B05B 5/053; B05B 5/025; H01J 49/16

(52) U.S. Cl. CPC B05B 5/0533; B05B 5/0255; H01J 49/167

(57) ABSTRACT

An electrospray generator includes a first electrode, a reservoir of liquid adjacent the first electrode, at least one wick having one end in the reservoir in contact with the liquid, a second electrode spaced a distance away from the wick, and a power source connected to one or more of the first and second electrodes. A method of generating a spray including inserting first ends of one or more wicks into a reservoir of liquid, the reservoir having a base electrode adjacent the liquid, positioning one or more offset electrodes at distance from second ends of the one or more wicks, and applying a voltage to at least one of the base electrode and the one or more offset electrodes to create an electric field, the electric field causing the liquid to move through the one or more wicks and form droplets in a spray.

### TECHNICAL FIELD

This disclosure relates to creation of aerosol droplets, more particularly to creation of aerosol droplets using an array of electrified wicks.

### BACKGROUND

Creating aerosol droplets with submicron diameters presents a considerable engineering challenge. Conventional spray nozzles, in which water is forced through a narrow orifice, produce mists with droplet diameters in the tens of microns to several millimeters. To decrease droplet size by a factor of ten, the pressure for a given nozzle must increase by more than 2,000 times. The pressures needed to produce submicron droplets require large amounts of energy, and can quickly lead to nozzle failure.

Other atomizers, like the ultrasonic nebulizers found in home humidifiers, can produce droplets with diameters of less than ten microns. However, these cannot produce smaller droplets without extremely high frequencies and high power requirements.

Electrospray atomization can produce submicron droplets. A large electrical field deforms the liquid surface at the end of a capillary, deforming it into a so-called Taylor cone. After formation of the cone, a narrow jet emits from the liquid surface quickly forming into small droplets. Electrospray is high tunable, produces droplets within a narrow size distribution, and produces charged droplets which are unlikely to coalesce into bigger drops.

The minimum field required to form the Taylor cone is:

$$E = {( \frac{2 γ cos θ}{{ε}_{0} {r}_{c}} )}^{1 / 2} ,$$

where γ is surface tension, r_{c} is capillary radius, ε₀ is permittivity, and θ is the Taylor cone angle, 49.3°. For water, which has a high surface tension of 73 mN/m, the turn-on field will exceed the breakdown strength of air, approximately 3 kV/mm, if the capillary radius is smaller than 1.2 mm.

In practice, arcs and air ionization occur at much lower fields, requiring much larger diameter capillaries. As capillary diameter increases, capillary pressure decreases, and steady feeding becomes difficult. Workarounds for water electrospray exist, such as operating in a vacuum, using high strength breakdown gas, or adding chemical surfactants to lower the surface tension. However, these increase system cost for particle production, or are undesirable for applications such as outdoor coatings and sprays.

### SUMMARY

According to aspects illustrated here, there is provided an electrospray generator including a first electrode, a reservoir of liquid adjacent the first electrode, at least one wick having one end in the reservoir in contact with the liquid, a second electrode spaced a distance away from the wick, and a power source connected to one or more of the first and second electrodes.

According to aspects illustrated here, there is provided a method of generating a spray including inserting first ends of one or more wicks into a reservoir of liquid, the reservoir having a base electrode adjacent the liquid, positioning one or more offset electrodes at distance from second ends of the one or more wicks, and applying a voltage to at least one of the base electrode and the one or more offset electrodes to create an electric field, the electric field causing the liquid to move through the one or more wicks and form droplets in a spray.

### BRIEF DESCRIPTION OF THE DRAWINGS

FIG. 1 shows an embodiment of a single wick.

FIG. 2 shows an embodiment of a two-dimensional array of wicks having varying sizes and shapes.

FIG. 3 shows a perspective view of an embodiment of a two-dimensional array of wicks.

FIG. 4 shows an embodiment of a three-dimensional array of wicks.

FIG. 5 shows a photograph of salt particles produced using an electrified wick.

### DETAILED DESCRIPTION OF THE EMBODIMENTS

The embodiments here enable electrospraying of water and other high surface tension liquids in air at atmospheric pressure and without the need for surfactants. Embodiments generally include an array of cylindrical wicks. Each wick has one end submerged in a liquid bath with an electrode at the bottom adjacent the liquid. Water travels up the wick via capillary action. In another embodiment, the wick end sits in a pressurized bath and has a liquid-tight seal to enable transport of liquid through the wick. A second electrode resides a distance at least two times the wick diameter away from and parallel to the other ends of the wick or wicks. An electrical field applied between the two electrodes causes the Taylor cone to form allowing extraction of droplets. Air flow, around or across the wicks, may direct the generated particles away from the electrode and towards the collector.

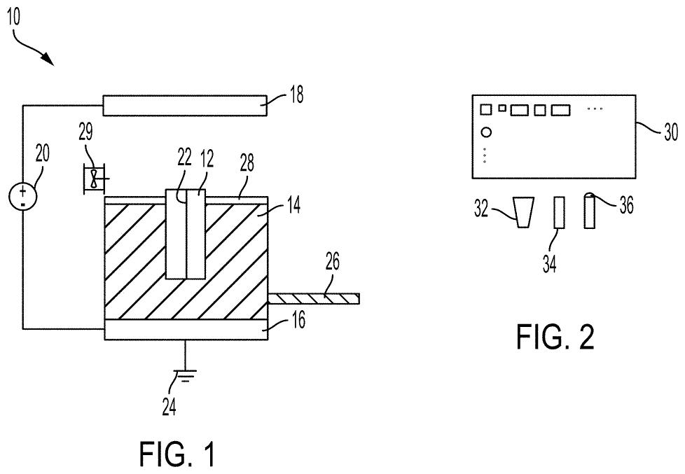

FIG. 1 shows an embodiment of an electrospray generator 10. The generator has one or more wicks 12. Each wick, such as 12, has one end in a reservoir of liquid 14 and the other end exposed to the atmosphere, typically air. A first electrode, referred to as a base electrode, 16 resides adjacent the reservoir, typically on a side of the reservoir opposite the end of the wick exposed to the atmosphere. An inlet 26 allows for the reservoir to be replenished as the liquid sprays out the wicks, as will be discussed in more detail later. The inlet 26 will typically connect to a liquid supply source. As mentioned above, the liquid in the reservoir could be pressurized and there would be a liquid-tight seal 28.

A second electrode, referred to as on offset electrode, 18 lies a predetermined distance away from the reservoir. In one embodiment this distance is twice the diameter of the one or more wicks. In one embodiment the electrode is a flat plate. In another embodiment the electrode contains holes such as 19 aligned with the wicks so that ejected droplets pass through the electrode. A voltage source 20 provides a voltage to the second electrode 18, with the first electrode 16 being grounded at 24, or the opposite. Alternatively, one electrode would be at a first potential and the other at a different potential. As long as a voltage differential exists, the result is an electric field. The voltage source has the capability to generate a voltage in the range of 1 kV to 70 kV, in one embodiment, the voltage source provides 20 kV, and in another it provides 50 kV. The current from the voltage source remains relatively low, In yet another embodiment there is a third electrode, an additional offset electrode, 17 positioned a further distance from the first electrode, for the purpose of accelerating droplets which pass through the second electrode. This third electrode is held at a higher positive or lower negative potential than the second electrode, in the case where the first electrode is grounded.

When the electrodes are activated, the liquid moves up through the wick and forms a Taylor cone between the wick 12 and the electrode 18. As the cone breaks up to form droplets, an air flow source 29, which may comprise a fan, allows the system to direct the droplets in a desired direction. The system may include other air direction components, such as baffles, not shown.

The wicks may have several different variations. For example, in FIG. 1, the wick 12 may have a wire 22 inserted. FIG. 2 shows an array of wicks 30. The array may have uniform sizes and spacing. Alternatively, they may have different sizes and spacing as shown in the FIG. 2. This may allow for tuning of the overall size distribution of the droplets produced by the device. In addition, the wicks may have different shapes, such as round, square, rectangular, at the tip, and the longitudinal shape may vary as well, such as tapered 32, cylindrical 34, may have a rounded tip 36.

Regardless of the configuration of the wicks, the array 30 of wicks such as 12 have one end in the reservoir with an electrode 24 at the bottom of the common reservoir and an electrode 18 spaced above the reservoir. The fan previously shown in FIG. 1 may direct the droplets generated by the various Taylor cones formed by each wick before they impact the other electrode 18.

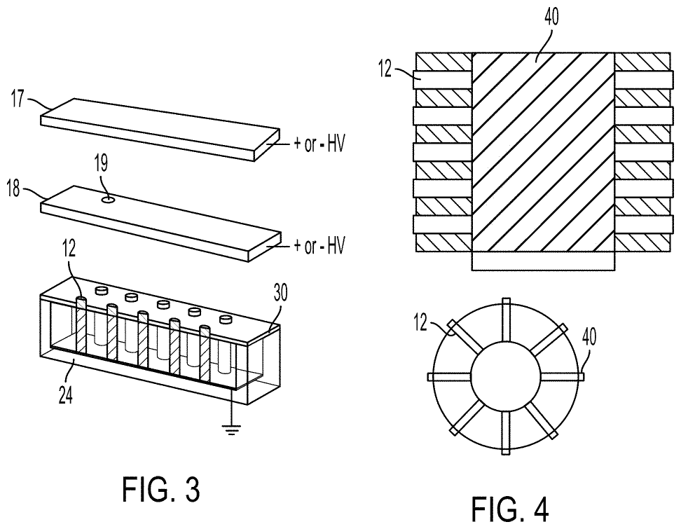

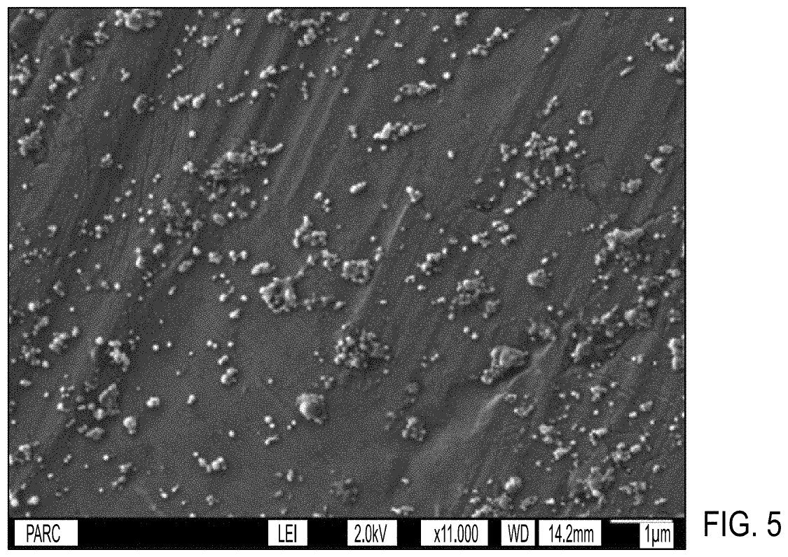

In FIGS. 1-3 the array is defined as two-dimensional array of wicks in that the wicks are arrayed in a roughly an x-y grid. FIG. 4 shows an embodiment of what is referred to here as a three-dimensional array, in which the wicks extend outwards from a cylinder or a sphere. The lower part of FIG. 4 shows a top view of the wicks 12 extending outwards from a cylinder and inside the reservoir 40. The term three-dimensional as used here means an array in which the wicks are arranged to have different depths or are arranged such that they are not flat.

In this manner, an array of wicks that can each form a Taylor cone to form submicron droplets without requiring excessive pressure or frequency requirements. Formation of submicron droplets allows for many different applications, including marine cloud brightening, formation of thin coatings and nanoparticle formation.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the embodiments.

What is claimed is:

1. An electrospray generator, comprising:
a first electrode;
a reservoir of liquid adjacent the first electrode;
at least one wick having a one end in the reservoir in contact with the liquid;
a second electrode spaced a distance away from the wick; and
a power source connected to one or more of the first and second electrodes.

2. The electrospray generator as claimed in claim 1, further comprising an air flow source located adjacent to the at least one wick.

3. The electrospray generator as claimed in claim 1, further comprising a liquid-tight seal around an outside of the at least one wick.

4. The electrospray generator as claimed in claim 1, wherein the reservoir is pressurized.

5. The electrospray generator as claimed in claim 1, wherein the at least one wick comprises a two-dimensional array of wicks.

6. The electrospray generator as claimed in claim 1, wherein the at least one non-metallic wick comprises a three-dimensional array of wicks.

7. The electrospray generator as claimed in claim 1, wherein the at least one wick comprises a plurality of wicks with at least two wicks have different diameters.

8. The electrospray generator as claimed in claim 1, wherein the wick comprises a non-metallic material.

9. The electrospray generator as claimed in claim 8, wherein the non-metallic material comprises one of cotton, natural fibers, synthetic fibers, open-pore aerogels, and porous polymers.

10. The electrospray generator as claimed in claim 1, wherein the at least one wick comprises two parts, a porous material, and a metallic wire in the porous material.

11. The electrospray generator as claimed in claim 1, wherein the at least one wick has a shape of one of cylindrical, conical, rounded, rectangular, or square.

12. The electrospray generator as claimed in claim 1, wherein the power source is connected to the first electrode and the second electrode is grounded.

13. The electrospray generator as claimed in claim 1, wherein the power source is connected to the second electrode and the first electrode is grounded.

14. The electrospray generator as claimed in claim 1, wherein the power source is capable of generating voltages in a range of 1 kV to 70 kV.

15. The electrospray generator as claimed in claim 1, further comprising a third electrode located on an opposite side of the second electrode from the reservoir, and the second electrode has at least one hole aligned with the at least one wick to allow droplets of the liquid to pass through the second electrode towards the third electrode.

16. A method of generating a spray, comprising:
inserting first ends of one or more wicks into a reservoir of liquid, the reservoir having a base electrode adjacent the liquid;
positioning one or more offset electrodes at distance from second ends of the one or more wicks; and
applying a voltage to at least one of the base electrode and the one or more offset electrodes to create an electric field, the electric field causing the liquid to move through the one or more wicks and form droplets in a spray.

17. The method as claimed in claim 16, further comprising using an air source to direct the droplets in a desired direction.

18. The method as claimed in claim 16, wherein positioning one or more offset electrode comprises positioning one offset electrode.

19. The method as claimed in claim 16, wherein positioning one or more offset electrodes comprises positioning two offset electrodes such that a first offset electrode is positioned between the one or more wicks and a second offset electrode, the first offset electrode having holes to allow the droplets to pass through.

20. The method as claimed in claim 19, further comprising holding the second offset electrode at a different voltage than the first offset electrode.
